(19) United States
(12) Patent Application Publication
(10) Pub. No.: US 2024/0183411 A1
(43) Pub. Date: Jun. 6, 2024

(54) ELECTRIC PARKING BRAKE AND METHOD FOR PRODUCTION THEREOF

(71) Applicant: ZF ACTIVE SAFETY GMBH, Koblenz (DE)

(72) Inventors: Michael SCHAEFER, Dohr (DE); Michael WEINS, Münstermaifeld (DE)

(21) Appl. No.: 18/552,932

(22) PCT Filed: Feb. 10, 2022
(86) PCT No.: PCT/EP2022/053271

§ 371 Date: Sep. 28, 2023

(30) Foreign Application Priority Data
Mar. 30, 2021 (DE) 10 2021 108 111.4

(51) Int. Cl. F16D 55/226; B60T 13/74; F16D 65/18; F16D 121/24; F16D 125/40

(52) U.S. Cl. CPC F16D 55/226; B60T 13/746; F16D 65/183; F16D 2121/24; F16D 2125/40; F16D 2250/0023

(57) ABSTRACT

An electric parking brake (100) has a spindle drive (28) which is electrically actuable and self-locking. The spindle drive (28) comprise a spindle (34) with an external thread and a spindle nut (30) with an internal thread which is in engagement with the external thread. Here, the external thread and the internal thread have a symmetrical thread profile. Furthermore, the profile edges of adjacent profile crests of the external thread merge directly into one another via a rounded portion in the profile trough which lies in between. Furthermore, a method for producing a parking brake (100) of this type is provided.

The invention relates to an electric parking brake which is electrically actuable and self-locking. Furthermore, the invention relates to a method for producing a parking brake of this type.

Electric parking brakes in general and specifically with a spindle drive are known from the prior art. These parking brakes can be used in motor vehicles and are provided to prevent the stationary motor vehicle from rolling in the engaged state of the parking brake. Here, the electric parking brake is adjusted and preloaded into an engaged position via an electric motor by means of spindle drive.

In the prior art, spindle drives with a sawtooth-shaped thread are usually used for electric parking brakes. Sawtooth profiles are highly suitable as a spindle drive and an electric parking brake, since they absorb the loads which act on one side in a highly satisfactory manner and have a high degree of efficiency as a result of steep load-bearing thread flanks.

In cost-driven mass production, the sawtooth profiles of spindles and spindle nuts are principally produced by means of forming methods. Here, a sawtooth profile is shown to be unfavorable, since especially the asymmetric design of the thread profile, that is to say the combination of a steep and a flat thread flank, can be produced by way of forming methods only with great difficulty. Here, the material rises into the steep thread flanks only reluctantly. This results in great closing folds and low degrees of closing of the thread profiles, which leads to insufficient overlap. Ensuring the required degrees of closure leads to low tool downtimes and long cycle times, which has a negative effect on the manufacturing costs.

Against this background, it is the object of the invention to provide an improved electric parking brake and an improved method for producing it.

In order to achieve the object, an electric parking brake is provided with a spindle drive which is electrically actuable and self-locking. The spindle drive comprises a spindle with an external thread or bolt thread and a spindle nut with an internal thread or nut thread which is in engagement with the external thread. Here, the external thread and the internal thread have a symmetrical thread profile. Furthermore, the profile flanks of adjacent profile crests of the external thread merge directly into one another via a rounded portion in the profile trough which lies in between.

Within the context of the invention, a symmetrical thread profile is understood to mean, in particular, a thread profile, the profile halves of which are of mirror-symmetrical design with respect to a center axis which extends in cross section radially through the profile crest.

It has been recognized in accordance with the invention that a spindle drive with a symmetrical thread profile instead of an asymmetrical thread profile has properties which meet high requirements of the spindle drive and/or the parking brake. It is decisive here that the profile troughs are rounded, in order for it to be possible for the stresses which are introduced into the thread under loading to be absorbed and therefore for a thread fracture to be avoided.

Here, furthermore, the symmetrical thread profile with a completely rounded profile trough has the advantage that, in comparison with an asymmetrical thread profile, it can be produced with less complexity and more reliably with high quality by way of forming, in particular by way of rolling.

Here, the rounded portion of the profile troughs of the external thread can have a radius between 0.18 mm and 0.22 mm, in particular of 0.2 mm.

In addition or as an alternative, the profile flanks of adjacent profile crests of the internal thread can merge directly to one another via a rounded portion in the profile trough which lies in between. Here, the rounded portion of the profile troughs of the internal thread can have a radius between 0.23 mm and 0.27 mm, in particular of 0.25 mm.

These radii of the rounded portions of the profile troughs of the external thread and the internal thread ensure a particularly high strength of the corresponding thread.

The values mentioned above and in the following text are values which are far away from geometries of spindles in accordance with DIN standards. The considerably less expensive spindles according to DIN standards, however, far and away do not provide the required properties for spindle drives of parking brakes which are partially greatly inconsistent with one another (for example, high clamping force, easy production capability and rapid adjustability, that is to say rapid stroke).

In one embodiment, the external thread and the internal thread have a flank angle between 26.5° and 29.5°, preferably between 27° and 29°, in particular of 28°. This comparatively small flank angle ensures that the spindle drive can provide a high preloading force. Furthermore, the thread with a flank angle of this type can be produced efficiently by means of forming methods.

In a further embodiment, the external thread and the internal thread have a pitch between 1.2 mm and 1.3 mm, in particular of 1.25 mm. By way of this comparatively small pitch, in comparison with the prior art, a higher loading force with an identical input torque can be achieved by way of corresponding thread dimensioning while meeting the strength requirements. Furthermore, this pitch affords a satisfactory compromise between a flat pitch which benefits the self-locking action of the spindle drive and a steep pitch which increases the speed, at which the spindle drive can be adjusted.

It can be provided that the external thread has a nominal diameter between 8.3 mm and 8.4 mm, in particular of 8.35 mm, as a result of which the spindle has a low mass with a sufficiently high strength.

In accordance with one embodiment, the external thread has a core diameter between 6.35 mm and 6.55 mm, preferably between 6.4 mm and 6.5 mm, in particular of 6.45 mm. In addition or as an alternative, the internal thread has a core diameter between 6.75 mm and 6.95 mm, in particular 6.85 mm. As a result, the spindle is particularly compact and can be manufactured in a material-efficient manner.

In accordance with one embodiment, the external thread has a flank diameter between 7.5 mm and 7.7 mm, preferably between 7.55 mm and 7.65 mm, in particular of 7.6 mm. In addition or as an alternative, the internal thread has a flank diameter between 7.7 mm and 7.9 mm, preferably between 7.75 mm and 7.85 mm, in particular of 7.8 mm. In this way, a particularly high overlap can be ensured.

Furthermore, the profile troughs and profile crests of the external thread and/or the internal thread at the level of the flank diameter can each have a width between 0.62 mm and 0.63 mm, in particular of 0.625 mm. A width of this type ensures a high strength and therefore reduces the risk of a thread fracture under load.

In addition or as an alternative, the external thread and/or the internal thread can have rounded profile crests. In this way, the threads can be produced in a cost-efficient manner, since rounded profile crests can be formed more easily during forming, in particular during rolling, and reworking of the profile crests can therefore be dispensed with.

According to the invention, in order to achieve the abovementioned object, a method for producing a parking brake according to the invention with the following step is also provided:

rolling the spindle after a final heat treatment of the spindle and/or heat treating the spindle nut after final rolling of the spindle nut.

This method has the advantage that the thread diameter can be reduced as a result of the finally rolled spindle and the high-strength spindle nut.

Particularly satisfactory functional properties were surprisingly shown by spindle drive with a spindle and a spindle nut produced in different ways, that is to say the spindle was rolled after a final heat treatment, and the nut was heat-treated after final rolling.

Further advantages and features result from the following description and from the appended drawings, in which:

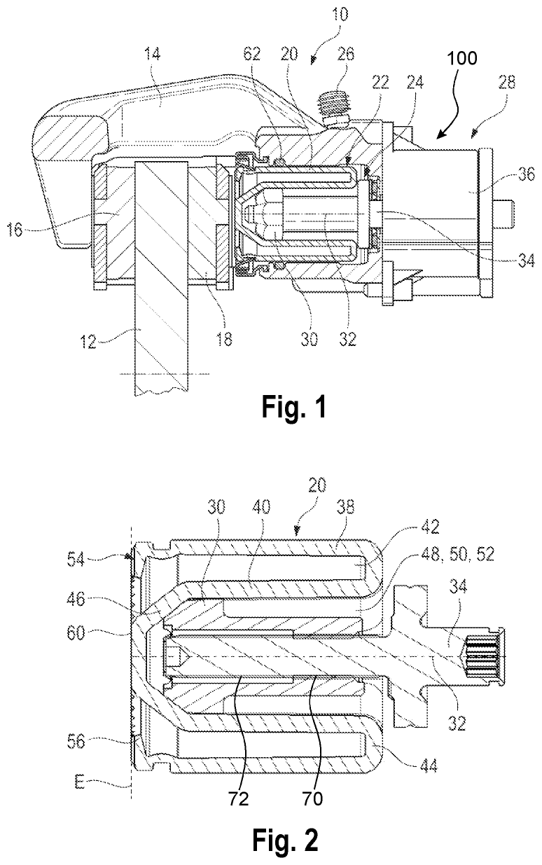

FIG. 1 shows a partially sectioned illustration of a brake caliper with a brake piston and an electric parking brake according to the invention which has a spindle drive with a spindle and a spindle nut, a portion of a brake disk additionally being shown,

FIG. 2 shows a sectional view of the spindle and a spindle nut of the spindle drive from FIG. 1 together with components of the brake piston,

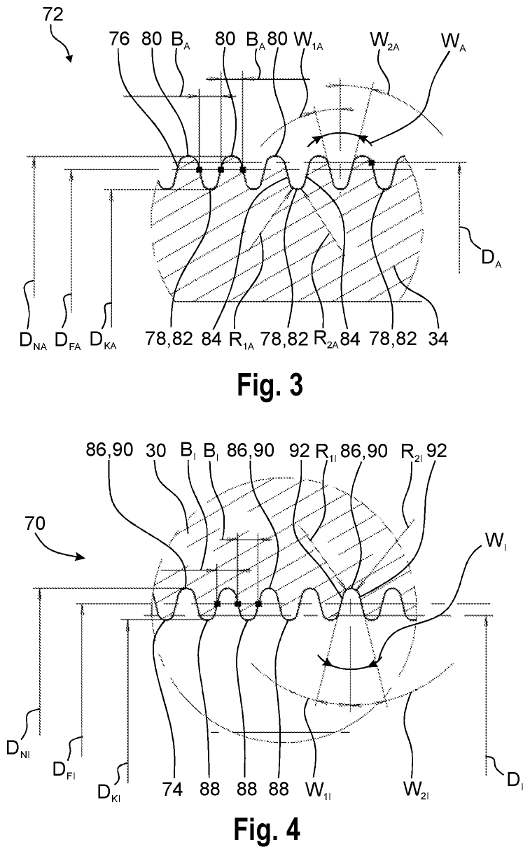

FIG. 3 shows a detailed view of the external thread of the spindle from FIG. 2, and

FIG. 4 shows a detailed view of the internal thread of the spindle nut from FIG. 2.

FIG. 1 shows a brake caliper 10 of a disk brake of a vehicle, which brake caliper 10 interacts with a brake disk 12.

The brake caliper 10 comprises a brake caliper body 14, to which a first brake lining 16 is fastened. The first brake lining 16 is therefore held immovably on the brake caliper body 14.

Moreover, a second brake lining 18 is provided which is mounted displaceably on the brake caliper body 14, with the result that it can be selectively pressed onto the brake disk 12 by means of a brake piston 20, in order to achieve a braking action.

For this purpose, the brake piston 20 is mounted displaceably in the cylindrical opening, here, for example, a fluid cylinder 22 which is configured on the brake caliper body 14.

Here, a pressure space 24 which can be loaded with pressure fluid is delimited by one end, facing away from the brake disk 12, of the fluid cylinder 22 and the brake piston 20.

The pressure space 24 is connected fluidically to a pressure fluid connector 26, via which air pressure fluid can selectively be introduced into the pressure space 24 and discharged from the latter.

For example, the pressure fluid is a hydraulic fluid. Therefore, the fluid cylinder 22 is a hydraulic cylinder.

The brake piston 20 can be moved hydraulically toward the brake lining 18 and the brake disk 12, with the result that the brake lining 18 is placed onto the brake disk 12 and brakes the latter. Since the brake caliper 10 can be displaced in the direction of the piston longitudinal axis 32 in accordance with the “floating caliper” principle, the brake lining 16 is also placed in parallel onto the brake disk 12 here.

Moreover, the brake piston 20 is coupled to an electric parking brake 100 which has a spindle drive 28.

It is to be emphasized, however, that the brake piston 20 with the functions described above and in the subsequent text can also be used in the case of a pure electromechanical brake and is received here in a cylindrical opening which can be configured as a bore or as an opening of a tubular cylinder.

In this context, a spindle nut 30 of the spindle drive 28 is mounted, as a result of its non-round outer contour, on the brake piston 20 fixedly so as not to rotate but axially displaceably along the piston longitudinal axis 32.

The spindle nut 30 interacts with a spindle 34 of the spindle drive 28, which spindle 34 is mounted on the brake caliper body 14 such that it can be rotated about the piston longitudinal axis 32 but is otherwise stationary. The spindle 34 can selectively be set in rotation by means of an electric drive motor 36.

Therefore, the brake piston 20 can also be moved toward the brake lining 18 and the brake disk 12 by means of the spindle drive 28, with the result that the brake linings 16 and 18 are pressed onto the brake disk 12 and brake the latter.

The brake piston 20 is shown together with the spindle nut 30 and the spindle 34 in detail in FIG. 2.

In this context, the brake piston 20 is constructed substantially from a first tubular piston body portion 38 and a second tubular piston body portion 40.

The two piston body portions 38, 40 extend along the piston longitudinal axis 32.

Here, the second piston body portion 40 is of slightly conical configuration with regard to the piston longitudinal axis 32. Here, its cross section decreases starting from that end which is arranged adjacently with respect to the spindle drive 28, in the direction of the brake lining-side end.

Furthermore, the second piston body portion 40 is arranged radially completely within the first piston body portion 38 in an axial view, with the formation of an annular cavity 42. In other words, the second piston body portion 40 lies completely within the first piston body portion 38 if the brake piston 20 is considered along the piston longitudinal axis 32. This embodiment is not to be understood as restrictive, however.

In the embodiment which is shown, the second piston body portion 40 additionally optionally lies axially completely within the first piston body portion 38. This means that the second piston body portion 40 does not project axially beyond the first piston body portion 38. This applies to the two axial ends of the second piston body portion 40.

Here, the first piston body portion 38 and the second piston body portion 40 are connected to one another via an annular end wall portion 44. The annular end wall portion 44 therefore also delimits the cavity 42 in the axial direction.

Moreover, the second piston body portion 40 is axially closed by way of a bottom portion 46 at its end which is opposite the end wall portion 44 along the piston longitudinal axis 32.

In the embodiment which is shown, the bottom portion 46 is frustoconical. It goes without saying, however, that it can also be shaped in a different way, for example in a flat or conical manner.

The second piston body portion 40 and the bottom portion 46 together form a cavity, in which the spindle nut 30 is received.

Here, an inner circumferential face 48 of the second piston body portion 40 has an anti-rotation contour 50.

For example, the anti-rotation contour 50 is formed by virtue of the fact that the second piston body portion has an octagonal cross section.

The spindle nut 30 which represents a region of the spindle drive 28 which protrudes into the anti-rotation contour 50 has a complementary cross-sectional geometry, that is to say is likewise octagonal, for example. Therefore, the spindle nut 30 cannot be rotated with respect to the brake piston 20.

However, the spindle nut 30 can be displaced within the second piston body portion 40 along the piston longitudinal axis 32.

Therefore, the inner circumferential face 48 also forms an axial guide contour 52 for the spindle drive 28, more precisely for the spindle nut 30.

Here, the abovementioned conicity of the second piston body portion 40 is so small that the spindle nut 30 can be guided over the entire axial length by means of the guide contour 52.

Moreover, a pressure face 54 is positioned at an axial end of the first piston body portion 38, which pressure face 54 serves to be placed onto the brake lining 18, that is to say to load the latter with force.

Here, the pressure face 54 extends over the axial end face of the first piston body portion 38 firstly and over an annular pressure face projection 56 which emanates radially inward from the end face.

In order to prevent a rotational of the brake piston 20 relative to the brake caliper body 14, it is connected via a mechanical coupling means (not shown) fixedly so as not to rotate, for example, to the brake lining 18, usually to what is known as the rear plate of the brake lining 18. For example, a projection is provided on the brake piston 20 or on the rear plate, which projection engages into a on the respective other component of brake piston 20 and rear plate, in order to bring about a coupling which is fixed so as not to rotate.

Moreover, the brake piston 20 is designed in such a way that the pressure face 54 and an axially outer end face 60 of the bottom portion 46 lie substantially in one plane E (see FIG. 2).

During operation of the brake piston 20, not only the pressure face 54 therefore bears against the brake lining 18, but rather also the end face 60.

Furthermore, the brake piston 20 is connected to the brake caliper body 14 in a frictionally locking manner via a seal 62.

The spindle nut 30 has an internal thread 70, and the spindle 34 has an external thread 72 which is in engagement with the internal thread 70.

The internal thread 70 and the external thread 72 are self-locking threads, and each have a symmetrical thread profile 74, 76 (see FIGS. 3 and 4), the geometry of which will be explained in the following text on the basis of FIGS. 3 and 4.

Here, the internal thread 70 and the external thread 72 have a pitch of 1.25 mm.

In an alternative embodiment, the pitch of the internal thread 70 and the external thread 72 is between 1.2 mm and 1.3 mm.

FIG. 3 shows the external thread 72 of the spindle 34 with a nominal diameter DNA, a core diameter DKA, a flank diameter DFA and a diameter DA, from which the rounded portion of the thread crest begins.

The nominal diameter DNA of the external thread 72 is 8.35 mm.

In an alternative embodiment, the nominal diameter DNA of the external thread 72 is between 8.3 mm and 8.4 mm.

The core diameter DKA of the external thread 72 is 6.45 mm.

In an alternative embodiment, the core diameter DKA of the external thread 72 is between 6.35 mm and 6.55 mm, preferably between 6.4 mm and 6.5 mm.

The flank diameter DFA of the external thread 72 is 7.6 mm.

In an alternative embodiment, the flank diameter DFA of the external thread 72 is between 7.5 mm and 7.7 mm, preferably between 7.55 mm and 7.65 mm.

The diameter DA of the external thread 72 is at least 8 mm here.

The external thread 72 has a flank angle WA which is composed of the two part angles W1A and W2A.

In the embodiment which is shown, the two part angles W1A and W2A are of identical magnitude, that is to say each of the part angles W1A and W2A is half as great as the flank angle WA.

The flank angle WA of the external thread 72 is 28°.

In an alternative embodiment, the flank angle WA of the external thread 72 is between 26.5° and 29.5°, preferably between 27° and 29°.

The profile troughs 78 and profile crests 80 of the external thread 72 each have a width BA of 0.625 mm at the level of the flank diameter DFA.

In an alternative embodiment, the width BA is between 0.62 mm and 0.63 mm.

The profile troughs 78 of the external thread 72 each have a rounded portion 82 which connects the profile flanks 84 of the profile crests 80, which are adjacent with respect to the profile troughs 78, directly to one another. In other words, the profile troughs 78 are configured without straight profile portions.

Furthermore, the profile troughs 78 are designed without corners.

Here, the rounded portions 82 of the profile troughs 78 of the external thread 72 have a first radius R1A at the transition to the one profile flank 84 and a second radius R2A at the transition to the opposite profile flank 84.

In the present exemplary embodiment, the radius R1A and the radius R2A are each 0.2 mm.

The profile troughs 78 is preferably formed only by way of one radius, that is to say the flanks which lie opposite one another merge into a trough which is formed exclusively by way of one radius, whereby the radii R1A and R2A coincide.

In an alternative embodiment, the radius R1A and/or the radius R2A are/is between 0.18 mm and 0.22 mm, the two radii being identical and it being possible for them to coincide as explained above.

The thread crest 80 is rounded in a complementary manner with respect to the thread trough 78, that is to say the rounded portion has the same radius as the thread trough 78, it also being possible here for only one radius to be provided which manages directly into the flanks.

FIG. 4 shows the internal thread 70 of the spindle nut 30 with a nominal diameter DNI, a core diameter DKI, a flank diameter DFI and an internal diameter DI.

The nominal diameter DNI of the internal thread 70 is 8.75 mm.

In an alternative embodiment, the nominal diameter DNI of the internal thread 70 is between 8.7 mm and 8.8 mm.

The core diameter DKI of the internal thread 70 is 6.85 mm.

In an alternative embodiment, the core diameter DKI of the internal thread 70 is between 6.75 mm and 6.95 mm.

The flank diameter DFI of the internal thread 70 is 7.8 mm.

In an alternative embodiment, the flank diameter DFI of the internal thread 70 is between 7.7 mm and 7.9 mm, preferably between 7.75 mm and 7.85 mm.

The diameter DI of the internal thread 70, from which the rounded portion of the thread crest 88 begins, is at most 7.12 mm here.

The internal thread 70 has a flank angle WI which is composed of the two part angles W1I and W2I.

In the embodiment which is shown, the two part angles W1I and W2I are of identical magnitude, that is to say each of the part angles W1I and W2I is half as great as the flank angle WI.

The flank angle WI of the internal thread 70 is 28°.

In an alternative embodiment, the flank angle WI of the internal thread 70 is between 26.5° and 29.5°, preferably between 27° and 29°.

The profile troughs 86 and profile crests 88 of the internal thread 70 each have a width BI of 0.625 mm at the level of the flank diameter DFI.

In an alternative embodiment, the width BI is between 0.62 mm and 0.63 mm.

The profile troughs 86 of the internal thread 70 each have a rounded portion 90 which connects the profile flanks 92 of the profile crests 88, which are adjacent with respect to the profile trough 86, directly to one another. In other words, the profile troughs 86 are configured without straight profile portions.

Furthermore, the profile troughs 86 are designed without corners.

Here, the rounded portions 90 of the profile troughs 86 of the internal thread 70 have a first radius R1I at the transition to the one profile flank 92 and a second radius R2I at the transition to the opposite profile flank 92.

In the present exemplary embodiment, the radius R1I and the radius R2I are in each case 0.25 mm, it also being possible, as in the case of the external thread, for the two radii to coincide here, with the result that the flanks merge directly into the same radius, with the result that the profile trough 86 is formed only by way of this singular radius.

In an alternative embodiment, the radius R1I and/or the radius R2I is between 0.23 mm and 0.27 mm, the two radii also being identical here.

As a result, the profile crests 80, 88 of the internal thread 70 and the external thread 72 are rounded, to be precise preferably with the same singular radius or the two radii R1I and R2I which were specified above.

On account of the rounded profile troughs 78, 86 and the rounded profile crests 80, 88, the internal thread 70 and the external thread 72 each form a round thread which, however, does not fall within DIN standards.

In order to produce the spindle drive 28, the spindle 34 is manufactured as follows.

In one step, the spindle 34 is thermally treated, in order to harden the spindle 34.

In the following step, the spindle 34 is rolled.

After the rolling, the spindle 34 is no longer thermally treated, that is to say the last thermal treatment before the rolling was a final thermal treatment.

In addition or as an alternative, in order to produce the spindle drive 28, the spindle nut 30 can be manufactured as follows.

In one step, the spindle nut 30 is rolled.

In a following step, the spindle nut 30 is thermally treated, in order to harden the spindle nut 30.

After the thermal treatment, the spindle nut 30 is no longer rolled, that is to say the last rolling before the thermal treatment was a final rolling, as a result of which it has a particularly high strength.

In this way, a spindle drive 28 is provided which has a particularly small thread diameter as a result of its finally rolled spindle 34 and high-strength spindle nut 30.

Furthermore, the specific geometry of the internal thread 70 of the spindle nut 30 and the external thread 72 of the spindle 34 ensures that the spindle drive 28 can be produced reliably by way of forming such as rolling and therefore with particularly low complexity.

Furthermore, the specific geometry of the internal thread 70 of the spindle nut 30 and the external thread 72 of the spindle 34 ensure that the spindle drive 28 and therefore the electric parking brake 100 meet particularly high requirements.

The following Table 1 shows a plurality of characteristic variables for a thread type “Thread A” and a thread type “Thread B”. Here, the thread type “Thread A” corresponds to one exemplary embodiment of the above-described spindle drive 28 with the specific geometry of the internal thread 70 of the spindle nut 30 and the external thread 72 of the spindle 34, while the thread type “Thread B” describes a spindle drive which differs therefrom and has a trapezoidal thread with a geometry inspired by DIN 103. DIN 103 provides at least a pitch of 1.5 in the case of a corresponding flank diameter, with the result that the pitch has been reduced in the example, in order to improve the self-locking action. Despite this optimization, the clamping force in the case of Thread A is considerably greater, which is the aim.

TABLE 1

| Thread | | | | | | | |
|---|---|---|---|---|---|---|---|
| type | S | T | U | V | W | X | Y |
| Thread | 1.25 | 7.700 | 77.98 | 14.00 | 0.148 | 25.11% | 18.929 |
| A | | | | | | | |
| Thread | 1.25 | 8.375 | 91.11 | 15.00 | 0.148 | 23.50% | 17.715 |
| B | | | | | | | |

where S=“pitch”, T=“flank diameter [mm]” of the thread pairing, U=“surface pressure at 17 kN [Mpa]”, V=“flank angle [°]”, W=“thread coefficient of friction”, X=“degree of efficiency” and Y=“clamping force at 15 Nm [kN]”.

As can be gathered from Table 1, a reduction in the flank diameter and in the flank angle in the case of Thread A in comparison with Thread B therefore leads to an increase in the degree of efficiency and to a higher clamping force or load-bearing capability of the spindle drive 28.

The brake caliper 10 can be operated as follows.

Proceeding from that position of the brake piston 20 which is shown in FIG. 1, it can be moved to the left, for example, by way of pressurization of the pressure space 24, with the result that it is placed onto the brake lining 18 and presses the latter onto the brake disk 12. As a result, a braking action is brought about.

In this context, the spindle drive 28 is not actuated, that is to say the spindle nut 30 does not move.

During its movement in the direction of the brake lining 18, a relative movement therefore occurs between the brake piston 20 and the spindle nut 30. This is made possible by the axial guide contour 52.

As an alternative, it is possible that the brake piston 20 is moved to the left by means of the spindle drive 28 of the electric parking brake 100, starting from the position shown in FIG. 1. For this purpose, the electric drive motor 36 is activated and the spindle 34 is set in rotation. Since the spindle nut 30 is mounted on the brake piston 20 fixedly so as to not rotate via the anti-rotation contour 50, the spindle nut 30 is moved to the left as a result. It is guided by the guide contour 52 in the process.

As soon as the spindle nut 30 comes into contact with the bottom portion 46 of the brake piston 20, it drives the brake piston 20 to the left with it during its movement.

In this way, the brake piston 20 is placed onto the brake lining 18 which is in turn pressed onto the brake disk 12, in order to bring about a braking action as explained above.

In this context, in addition to the abovementioned rotary coupling to the rear plate, the brake piston 20 is held on the brake caliper body 14 in a frictionally locking manner on account of its frictional contact with the seal 62, in such a way that it does not rotate.

As soon as the brake piston 20 is in contact with the brake lining 18, this contact also brings about an anti-rotation safeguard of the brake piston within the brake caliper body 14.

In this way, the elastic parking brake 100 can be adjusted into an engaged state, in which it presses the brake lining 18 via the spindle drive 28 with a stressing force of at least 16.5 kN onto the brake disk 12 and therefore holds the vehicle reliably in a parked or stopped position.

The invention is not restricted to the embodiment which is shown. In particular, individual features of one embodiment can be combined as desired with features of other embodiments, in particular independently of the other features of the corresponding embodiments.

Furthermore, the electric parking brake 100 can be provided separately from or in combination with any desired brake of a vehicle, in particular with any desired brake caliper 10.

1. An electric parking brake (100), with a spindle drive (28) which is electrically actuable and self-locking, comprising a spindle (34) with an external thread (72) and a spindle nut (30) with an internal thread (70) which is in engagement with the external thread (72),
wherein the external thread (72) and the internal thread (70) have a symmetrical thread profile (74, 76), the profile flanks (84) of adjacent profile crests (80) of the external thread (72) merging directly to one another via a rounded portion (82) in the profile trough (78) lying in between.

2. The parking brake (100) as claimed in claim 1, wherein the rounded portion (82) of the profile trough (78) of the external thread (72) has a radius (R_{1A}, R_{2A}) between 0.18 mm and 0.22 mm, in particular of 0.2 mm, and/or in that the profile flanks (92) of adjacent profile crests (88) of the internal thread (70) merge directly into one another via a rounded portion (90) in the profile trough (86) which lies in between, the rounded portion (90) of the profile troughs (86) of the internal thread (70) having a radius (R_{1I}, R_{2I}) between 0.23 mm and 0.27 mm, in particular of 0.25 mm.

3. The parking brake (100) as claimed in claim 1, wherein the external thread (72) and the internal thread (70) have a flank angle (W_{A}, W_{I}) between 26.5° and 29.5°, preferably between 27° and 29°, in particular of 28°.

4. The parking brake (100) as claimed in claim 1, wherein the external thread (72) and the internal thread (70) have a pitch between 1.2 mm and 1.3 mm, in particular of 1.25 mm.

5. The parking brake (100) as claimed in claim 1, wherein the external thread (72) has a nominal diameter (D_{NA}) between 8.3 mm and 8.4 mm, in particular of 8.35 mm.

6. The parking brake (100) as claimed in claim 1, wherein the external thread (72) has a core diameter (D_{KA}) between 6.35 mm and 6.55 mm, preferably between 6.4 mm and 6.5 mm, in particular of 6.45 mm, and/or the internal diameter (70) has a core diameter (D_{KI}) between 6.75 mm and 6.95 mm, in particular 6.85 mm.

7. The parking brake (100) as claimed in claim 1, wherein the external thread (72) has a flank diameter (D_{FA}) between 7.5 mm and 7.7 mm, preferably between 7.55 mm and 7.65 mm, in particular of 7.6 mm, and/or the internal thread (70) has a flank diameter (D_{FI}) between 7.7 mm and 7.9 mm, preferably between 7.75 mm and 7.85 mm, in particular of 7.8 mm.

8. The parking brake (100) as claimed in claim 1, wherein the profile troughs (78, 86) and profile crests (80, 88) of the external thread (72) and/or of the internal thread (70) each have, at the level of the flank diameter (D_{FA}, D_{FI}), a width (B_{A}, B_{I}) between 0.62 mm and 0.63 mm, in particular of 0.625 mm.

9. The parking brake (100) as claimed in claim 1, wherein the external thread (72) and/or the internal thread (70) have/has grounded profile crests (80, 88).

10. A method for producing a parking brake (100) as claimed in claim 1 with the following step:
rolling the spindle (34) after a final heat treatment of the spindle (34) and/or heat treating the spindle nut (30) after final rolling of the spindle nut (30).
